(19) United States
(12) Patent Application Publication
(10) Pub. No.: US 2014/0302814 A1
(43) Pub. Date: Oct. 9, 2014

(54) CENTRALIZED CALLER PROFILE AND PAYMENT SYSTEM AND METHODS FOR PROCESSING TELEPHONE PAYMENTS

(71) Applicants: Ian James Roncoroni, Phillipsburg, NJ (US); Gianni Martire, Englewood Cliffs, NJ (US)

(72) Inventors: Ian James Roncoroni, Phillipsburg, NJ (US); Gianni Martire, Englewood Cliffs, NJ (US)

(21) Appl. No.: 14/246,598

(22) Filed: Apr. 7, 2014

Related U.S. Application Data
(63) Continuation-in-part of application No. 14/070,059, filed on Nov. 1, 2013.
(60) Provisional application No. 61/724,100, filed on Nov. 8, 2012.
(60) Provisional application No. 61/722,005, filed on Nov. 2, 2012.

(51) Int. Cl. H04M 15/00; G06Q 20/40

(52) U.S. Cl. CPC H04M 15/48; H04M 15/41; G06Q 20/4012
USPC 455/408

(57) ABSTRACT

A centralized caller profile and billing system provides methods for routing and prioritizing calls and for providing billing information and payment. The systems and methods provide enhanced customer service by allowing multiple parties to update and share the same set of profile information from a centralized database. Faster and easier access to profile information is provided, allowing more efficient call routing and the ability to prioritize callers in a caller queue. When a caller connects with a called party, a centralized database of caller information is automatically applied to the caller, thereby eliminating the need for verbal billing requests. Billing information is sent from the centralized caller database to a payment gateway upon verification of a caller's PIN. The billing information is sent conveniently and securely. Security is improved because the billing information can be communicated directly to the payment gateway, third party, or other agent.

### CROSS REFERENCE TO RELATED APPLICATIONS

This application is a continuation-in-part application of U.S. patent application Ser. No. 14/070,059 filed on Nov. 1, 2013, which claims priority to U.S. Provisional Patent Application No. 61/724,100, filed on Nov. 2, 2012, and to U.S. Provisional Patent Application No. 61/722,005, filed on Nov. 2, 2012, the entire disclosures of which are incorporated herein by reference.

### TECHNICAL FIELD

This technology relates to systems, devices, and methods of identifying, routing, and prioritizing calls. More particularly, the technology relates to identifying callers and providing billing information electronically via a secure database.

### BACKGROUND

People transact business over the phone and have been doing it the same way for decades. The person ordering an item or paying a bill has to go through the time consuming and unsecured process of reading credit/debit card, or bank account information out loud, having that information saved on a recorded line, and ultimately given to an anonymous representative. There are many stages in this process where theft and fraud may occur. Not only is this process risky, it is also time consuming for both the customer and the business.

Currently, when people transact business over the phone, they are forced to deal with a cumbersome process of reciting information for the agent to hear. This causes miscommunication, and opens up the customer to fraudulent attacks.

In most cases, placing a telephone call conveys only the user's telephone number and name. All remaining information (including profile information and billing information) must be provided orally—dictated to the called party or agent each time.

The first prototype of modern Caller ID was developed in 1971 by Theodore Paraskevakos. In patents related to those devices, he proposed to send alphanumeric information to the receiving apparatus, and this was received with great success. His invention was improved by Japanese inventor Kazuo Hashimoto, who in 1976 built a prototype of a Caller ID display device that could receive Caller ID information. The first market trial for Caller ID was conducted by BellSouth in 1984. Since 1984, there has been very little innovation to traditional caller ID. In 1995, call waiting ID was introduced by Bellcore, but this only allowed caller ID to be transmitted while the user was simultaneously on the phone; it did not make any improvement to traditional caller ID.

Rising popularity of cellular phones is actually making caller ID increasingly obsolete; most networks do not support the necessary infrastructure to support the transmission of this data. For this reason, carriers report the name as “unavailable” or “wireless caller.” In 2002, mobile users surpassed landline subscribers, and in 2013, cell phones outnumber landlines 5:1.

Regardless of the platform or carrier, Caller ID suffers from at least one significant disadvantage: the technology provides only the caller's number and name to the called party. Numerous attempts have been made to improve upon these capabilities.

### SUMMARY

The centralized caller profile and payment system of the claimed invention identifies callers and provides profile information and billing information about the callers. The systems and methods of the claimed invention transmit sensitive caller information securely to avoid interception and detection. For example, sensitive caller information can be transmitted to a secure third-party gateway.

The centralized caller profile and payment system of the claimed invention rapidly identifies callers and provides caller profile information to the called party and/or to the called party's agents. Billing information relating to the caller can be provided to the called party or to its agents. The centralized caller profile and payment system provides a method of automatically identifying a caller and intelligently transferring that caller to an appropriate call designation or agent.

The systems and methods of the claimed invention automatically apply a centralized database of information to in incoming caller, eliminating the step of requesting the information verbally. Caller profiling capabilities are extended beyond identifying an incoming caller with caller ID and automatically looking up the profile of the caller in a cloud database. Billing information and payment processes are incorporated in a system that allows a party engaged in a verbal (spoken) telephone call to unlock centrally stored billing information, transmitting it directly to a payment gateway. These capabilities provide improved convenience and security than a caller speaking the billing information to the called party. Security is improved because the billing information can be communicated directly to a payment gateway, third party, or other agent.

Additionally, the systems and methods of the claimed invention provide a way for transmitting billing information to a called party's payment gateway while avoiding either (a) transmitting that information to the called party; or (b) manually entering that billing information. Many devices allow customers to use their phones as payment devices. These devices are mostly used in point of sale transactions, and do not allow someone to transact business with an agent during a call. The systems and methods of the claimed invention can transmit this data electronically via a secure database. By transmitting billing information electronically, the human element of theft can be almost completely eliminated.

The centralized caller database of the claimed invention can be a cloud based database that includes personal information about the caller (also referred to as “content” in this disclosure). The system uses the caller's telephone number to catalog the information for a given caller. When the caller contacts a called party, the system uses the phone number to identify the caller, query the database, and send profile information to the called party and/or the agent. This way the agent knows all about the caller when answering the phone. Although both are “content,” personal information is different from billing information.

The system and method of the claimed invention also add a personal identification number (PIN) component of the system. PIN information of callers is stored in the cloud database. When a caller contacts a called party, the agent verifies the PIN (provided by the caller) with the system's record for that caller on the cloud database. If the PINs match (i.e., the caller's PIN is verified), then the system releases the billing information from the cloud database to the payment gateway.

The billing information is kept secure. The agent never sees the billing information, except for an identifier telling which account it is. The agent verifies the PIN by communicating the PIN to the cloud database, and when the PINs match, the cloud database of the system sends the billing information to the payment gateway.

In one example embodiment of the claimed invention, a telephone payment system for processing a telephone payment of a caller includes a called party computer and a contact database. The called party computer can be configured to receive a telephone call from the caller, to receive a unique identifier from the caller, and to receive a PIN from the caller. The unique identifier received by the called party computer can include a telephone number of the caller.

The called party computer can be configured to receive a PIN from a caller electronically, verbally, or in another fashion. The PIN can be letters, numbers, symbols, words, and combinations of letters, numbers, symbols, and words. The called party computer can be further configured to transmit the received PIN to the contact database. The contact database stores profile information records, including a profile information record of the caller corresponding to the unique identifier of the caller. The contact database also stores billing information records, including a billing information record of the caller corresponding to a PIN associated with the caller.

The contact database is designed and manufactured to transmit billing information from the billing information record of the caller to a payment gateway for processing the telephone payment of the caller when the PIN received by the called party computer matches the PIN associated with the caller stored in the contact database. The contact database can be further configured to transmit the billing information directly from the contact database to the payment gateway without providing the billing information to the called party computer. The contact database can be a cloud database, for example. The billing information transmitted from the contact database to the payment gateway can include credit card information, bank information, and/or additional billing information that enables payment for goods and services purchased by the caller to be received by the payment gateway. The billing information can be encrypted by the contact database prior to transmission to the payment gateway. Upon receipt of the encrypted billing information, the payment gateway can decrypt the billing information.

A method for processing a telephone payment of a caller carried out by the telephone payment processing system includes establishing a telephone connection between a caller and a called party and having the called party acquire or otherwise receive a unique identifier from the caller. The unique identifier can include a telephone number of the caller, for example. The called party queries a contact database for a profile information record corresponding to the unique identifier. The contact database can be a cloud database, for example. The called party also receives a PIN associated with the caller. The PIN can be received verbally or electronically (e.g., provided by the caller using a touch tone keypad) by the called party. The called party can then provide the received PIN to the contact database and compare the received PIN to a PIN in the profile information record of the caller.

When the PIN received matches the PIN in the profile information record of the caller in the contact database, the contact database can transmit billing information of the caller to a payment gateway for processing the telephone payment of the caller. The billing information of the caller transmitted to the payment gateway can include bank account information, credit card information, and the like. The billing information can be encrypted prior to transmission and decrypted upon receipt by the payment gateway. The billing information, either encrypted or not, can be provided directly from the contact database to the payment gateway without being provided to the called party.

### BRIEF DESCRIPTION OF THE DRAWINGS

FIG. 1 illustrates an example of the process flow for prioritizing calls in accordance with the claimed invention.

FIG. 2 shows a universal database in accordance with the claimed invention that stores and updates user profile information.

FIG. 3 illustrates a centralized caller profile system in accordance with the claimed invention and the different parties/entities interacting and exchanging information with the system.

FIG. 4 shows an example telephone payment system in accordance with the claimed invention and the manner in which different parties interact within the system.

FIG. 5 shows an example telephone payment system in accordance with the claimed invention that includes an additional agent.

### DETAILED DESCRIPTION

The claimed invention includes a system and method for looking up and selectively distributing content, such as profile information (including billing information), for callers. A centralized caller profile system for authenticating and identifying callers provides benefits beyond existing systems and methods because it eliminates the need for expensive additional hardware and allows multiple parties to access the same set of information from a centralized database. In one example embodiment, the centralized database is maintained by an outside system/network, such as a cloud database. The systems and methods of the claimed invention are far less costly and more efficient than previous systems.

For example, the “cloud database” can be a database that typically runs on a cloud computing platform. The term “cloud computing” describes a variety of computing concepts that involve a large number of computers connected through a real-time communication network such as the Internet. In one sense, cloud computing is a synonym for distributed computing over a network and means the ability to run a program on many connected computers at the same time. The term cloud computing is also commonly used to refer to network-based services which appear to be provided by real server hardware, which in fact are served up by virtual hardware, simulated by software running on one or more real machines. Such virtual servers are not physically constrained and can therefore be moved around and scaled up (or down) on the fly without affecting the end user.

Examples of popular cloud computing platforms include Amazon EC2, GoGrid and Rackspace. Two example deployment models can be used to affect the system of the claimed invention. Users can run databases on the cloud independently, using a virtual machine image, or they can purchase access to a database service, maintained by a cloud database provider. Of the databases available on the cloud, some are SQL-based and some use a NoSQL data model.

The systems and methods of the claimed invention also provide a caller profile system and service that provides third parties the ability to rapidly identify a caller via a centralized caller profile database. A caller profile can include any type of content, including text, images, and/or other forms of multimedia content. “Text” can include all alphanumeric characters and languages. Content can include aural (i.e., spoken) content, videos, and animations. In one example embodiment of the claimed invention, the content is profile information. The profile information is updated and maintained by the users who created them. Once created and established, these profiles are delivered to called parties with (the delivery of) each call and/or at the request of the user.

Profile information can include textual, image, sound, video, or animated representations about a particular entity, e.g., a human being. For example, profile information can include textual information such as name, address, employment, spoken language, buying preferences, age, hobbies, and the like. Profile information can also include information typically found on social media or business networking sites, such as, for example, LinkedIn or Facebook.

Similarly, billing information can include name, address, and other information required to complete a sales transaction. In one example embodiment, billing information includes information chosen from credit card number, credit card verification code, checking account, bank routing number, credit rating, and the like.

Once the caller profiles are created and stored in the NextCaller universal database, incoming calls can be prioritized based upon the existence of the caller profile and the information in the caller profile.

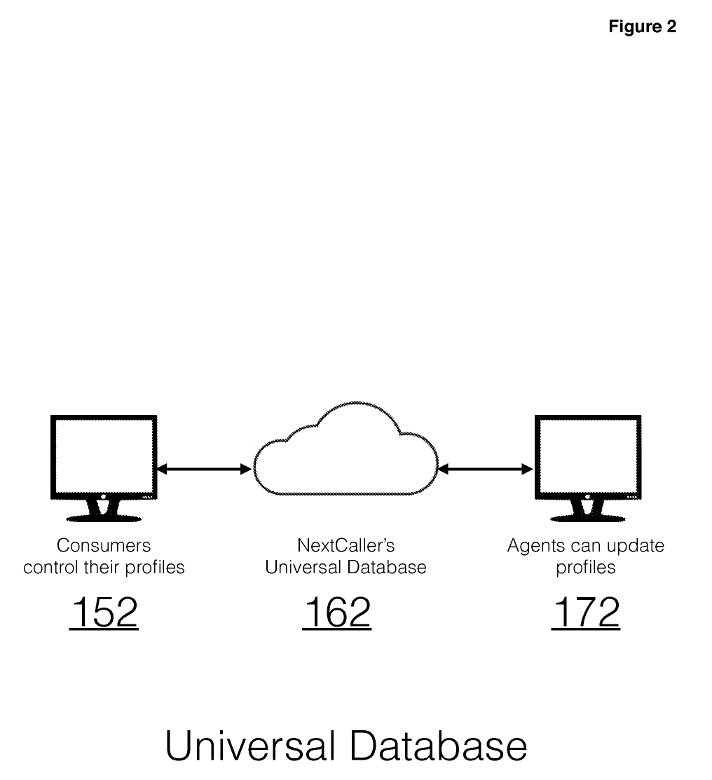

FIG. 2 shows a universal database feature of the claimed invention. In FIG. 2, consumers 152 interact with the NextCaller universal database 162. The NextCaller universal database 162 can include a cloud database for storing, maintaining, editing, and updating caller profile information. Caller profile information can include particular representations of personal information associated with a particular person or entity. In one example embodiment, a caller profile comprises the name, address, telephone number, and email address for a particular person.

Consumers (i.e., callers) 152 can create, edit, update, maintain, and store their profile information on a computer-readable medium in the NextCaller universal database 162. The user (caller 1) can also permit the profile information to be stored in a corporate, public, or user-operated caller profile database. By giving an agent or third party permission to view or access or modify the profile information, the agent and third party can accurately and readily identify the user. In this manner, agents 172 or other third parties can amend the profile information stored in the computer-readable medium records in the NextCaller universal database 162.

For example, the Content (e.g., caller profile information and/or billing information) can be stored in a caller profile database operated by a service provider, but may also be stored in a corporate or user operated caller profile database. In the example embodiment shown in FIG. 2, the caller profile information is stored in the NextCaller universal database 162. Regardless of the manner in which the content is stored, the content can be created and revised by the user, as needed, using a network terminal, such as a computer-based World Wide Web browser, or an interactive voice response system. Updates and revisions are registered and stored in the caller profile database (contact database 162) and can be sent at the users' discretion to third parties, including agents 172 and other third parties.

Agents and third parties are able to access a caller's associated content (e.g., the caller's profile information) a profile identifier. The profile identifier is a unique identifier used to determine the identity of the caller. In one example embodiment, the profile identifier can be the caller's unique identifier, which can be a telephone number, email address, or other unique record locator unique to the caller. The “unique identifier” is a piece of information sufficient to specify one thing or record amidst a larger number of possibilities. Additional examples of unique identifiers include a sequence of numbers, letters, or symbols, which is used to identify one specific entity or record. Within the context of a database (e.g., the cloud database described above), a unique identifier is unique among all identifiers used for the objects and records housed in the database and used for a specific purpose. In one example embodiment, a unique identifier can be a Caller ID (caller identification, CID), a.k.a. calling line identification (CLID), calling number delivery (CND), calling number identification (CNID), or calling line identification presentation (CLIP). In another example embodiment, a Unique Identifier can be a mobile identification number (MIN) or mobile subscription identification number (MSIN). The unique identifier can be any reliable identification feature provided by the caller and retrievable by the called party.

The unique identifier acquired by the called party from the caller can be used as a record locator in the cloud database. However, the cloud database need not use the unique identifier as the only record locator in the cloud database. For example, the unique identifier initially acquired from the caller can be converted into a different, easier to use identifier on the cloud database. One advantage of converting the unique identifier initially acquired from the caller into a different record locator is avoiding problems with duplicate numbers when handling international callers.

The caller's unique identifier can be used to select which user's profile to view and can be sent via telephone call, electronic message, or any other method by which the user can communicate directly or indirectly with an agent or third party. This user profile can be used by agents and third parties in a way that is helpful to that party and to its business, or in any way the information is important to the relationship between the user and the party.

Automatically identifying the caller and providing the service provider with information about the caller provides value to the user (caller) by making the exchange of personal data over the phone faster and more efficient. The caller no longer has to verbally exchange this information and risk miscommunication with the called party. The agent or third party accessing the profile information benefits from the claimed systems and methods by saving valuable agent time in gathering this necessary information. Normally, the agent or third party's businesses also save time and money by having up-to-date customer information, which reduces errors in shipping, billing, soliciting, and the like.

The claimed invention includes a centralized caller profile system, telephone payment system, and methods of processing telephone payments. One example embodiment of the claimed invention includes a centralized caller profile system with multiple parties (i.e., a caller, a called party, a cloud database, and communication lines between the parties. The method includes the called party retrieving a unique identifier from the caller, transmitting the unique identifier to the cloud database, and the cloud Database transmitting Content from the cloud database to the called party.

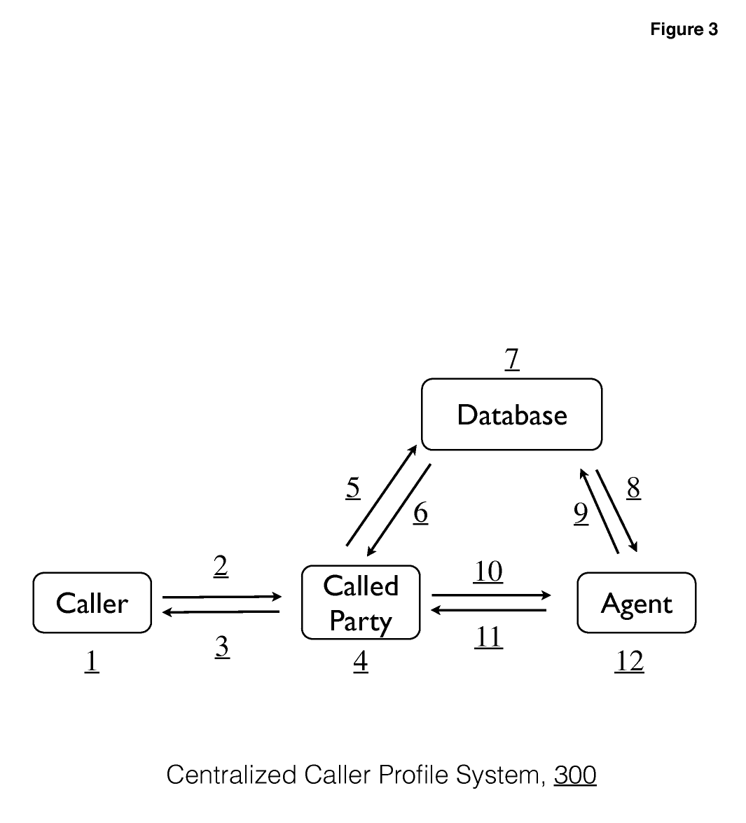

The centralized caller profile system 300 shown in FIG. 3 efficiently authenticates and identifies callers. The system 300 simplifies and expedites the exchange of personal information from users (callers) to and agents and third parties. The system 300 of the claimed invention achieves this efficiency by using a database 7, such as a cloud database, that houses, utilizes, and distributes profile information to agents 12 and third parties that have permission to access the information. The profiles contained in the database 7 are created, modified, maintained, and distributed by the user (caller 1), or by an agent 12 or third party at the request of the user (caller 1).

For example, the centralized caller profile system 300 includes a caller 1, a called party 4, a database 7, and an agent 12. A “caller” can be a calling party, that is, the party placing or initiating a call, especially a telephone call, to a called party. A “called party” can be any party receiving a call from a caller.

In one embodiment, the cloud database is linked to a third party receiving the customer's (caller's) call via the telephone, World Wide Web, or any other means of communication. The third party can be an agent or another intelligent entity with whom a caller can interact or converse, e.g., about particular goods or services. In one example embodiment, the intelligent entity is an intelligent entity answering the telephone call and engaging the caller in conversation. In one example embodiment, the agent is a human customer service representative. In one example embodiment, the agent includes a person answering telephone calls within the customer service department of a business. In one embodiment of the disclosed centralized caller profile system, the Agent can be a non-human entity, such as an interactive voice response (“IVR”) system.

At any point during the call, if the caller wishes to reveal information in the database, he or she may provide the PIN (i.e., number, password, or unique identifier) to the called party or to the agent on the phone. If the PIN provided matches the security code saved in the user's profile in the cloud database, the cloud database then sends that information electronically to the agent. In a case where the agent's computer is linked to the database, the information would be sent directly to the agent's computer.

The arrows in FIG. 3 show the interconnectivity of these entities by representing the transfer (i.e., transmission) and/or retrieval (i.e., acquire or receive) of profile information, including user data through real-time connectivity and telephone connections. A “telephone connection” can be a live connection between two or more parties, where at least one party is connected via a telephone. For example, a telephone conversation between two participants would include a telephone connection, through which the participants converse. In at least one example embodiment, the live telephone connections between two or more parties include the real-time exchange of spoken or verbal information via the telephone connection.

As shown in the centralized caller profile system 300 of FIG. 3, a caller 1 can transmit profile information to the called party 4 along communication line 2 to establish a telephone connection. Likewise, the called party 4 can transmit profile information to the caller 1 along communication line 3 so that the caller retrieves information. Typically one party is sending information while the other party is retrieving information. “Transmitting” includes causing data or a signal to pass on from one location or person to another. It can also include broadcasting or sending out, such as an electrical signal, a digital signal, an audio signal, or a radio signal. In one example embodiment, transmitting includes sending a unique identifier to a cloud database via an Internet connection. For example, a called party can perform a Caller ID lookup for an incoming caller, transmitting that telephone number information to the cloud database as described below. Retrieving can include actively requesting or accepting available information from a party to a particular connection. For example, during a telephone call, the called party may use known methods (e.g., Caller ID) of retrieving the telephone number of a caller.

In FIG. 3, the called party 4 can access and/or send profile information to database 7, such as a cloud database, along communication line 5. The database 7 can transmit profile information to the called party 4 along communication line 6. Further, the database 7 can transmit profile information and other information to the agent 12 along communication line 8. The agent 12, in turn, can transmit profile and other information to update the database 7 using communication line 9. The called party 4 can also transmit profile information directly to the agent 12 using communication line 10, without the need to contact the database 7 in the interim. Similarly, the Agent 12 can transmit updated and other profile information directly to the called party 4 along communication line 11.

In one example embodiment of the claimed invention, the centralized caller profile system 300 includes a caller 1 transmitting audio to the agent 12. Audio can include sound, such as spoken language. This can include the caller speaking into a telephone and transmitting the spoken words to the agent, via a telephone call. Similarly, in one example embodiment, the centralized caller profile system 300 includes the agent 12 transmitting audio from to the caller 1. This can include a telephone connection over communication lines 2 and 10 from the caller to the agent, and over communication lines 11 and 3 from the agent to the caller.

In one example embodiment of the claimed invention, the centralized caller profile system 300 includes transmitting Amended content from the agent 12 to the cloud database 7. Likewise, the centralized caller profile system 300 can affect transmission of amended content from the caller 1 to the cloud database 7. Amended content can include revised content that differs from a previous version stored and associated with a particular record. For example, users (callers 1) can update, edit, and revise some or all of their bibliographic information, address, billing information, customer preferences, and the like. For a specific database record, the content associated with a specific user can be changed by a remote user (e.g., the agent 12 or the caller 1) of the centralized caller profile system 300. To update the specific database record, the remote user would send amended content to the database 7, and update the database to change the then-existing content to the new amended content, updating the content stored in the database. Record can include a group of related data, words, or fields treated as a meaningful unit. For example, data, words, and/or fields can be grouped together as a record by associating them with a common unique identifier.

One example embodiment of the claimed invention includes a method of providing a caller profile to an agent. The method includes establishing a telephone connection 3 between called party 4 and a caller 1. Establishing a telephone connection between a called party 4 and a caller 1 can be accomplished by the called party's receiving and answering an incoming telephone call from a caller 1. From the standpoint of a caller 1, establishing a telephone conversation can be accomplished by placing a telephone call to an entity known to answer telephone calls and waiting for the called party 4 to answer the telephone. In another example, a caller 1 requests that the called party 4 establishes a telephone connection.

Once the connection is established, the called party 4 acquires a unique identifier from the caller 1 and transmits the unique identifier to a cloud based database 7 over communication line 5. The called party 4 queries the cloud based database 7 for a record corresponding to the Unique Identifier provided by the caller 1. That is, the called party 4 queries the cloud based database 7 for a record that is associated or grouped together with a particular thing. Content corresponding to a particular unique identifier would all be associated with (e.g., tagged, marked, designated) that unique identifier, such that querying for the unique identifier would reciprocally return that content. The database 7 identifies content associated with the unique identifier and transmits the content associated with the unique identifier to the called party 4.

In one example embodiment, the method of providing a caller profile to an agent 12 includes transmitting content associated with a caller's unique identifier to the agent 12. The caller 1 can transmit content associated with a caller's unique identifier to the agent 12 as can the called party 4 and/or the database 7. In one embodiment, the method of providing a caller profile to an agent includes establishing a telephone connection between the caller 1 and the agent 12. In one embodiment, the method of providing a caller profile to an agent 12 includes acquiring the telephone number of the caller 1. Additionally, in one example embodiment, the method of providing a caller profile to an Agent 12 includes transmitting the telephone number of the caller 1 to the cloud database 7. Also, in one embodiment, the method of providing a caller profile to an agent 12 includes querying the cloud based database 7 for a record corresponding to the telephone number of the caller 1. Querying can include searching for a particular text, image, sound, video or animation. A method of the claimed invention can also include providing a caller profile to an agent 12 that includes transmitting audio from the caller 1 to the agent 12. Transmitting audio from the caller 1 to the agent 12 can include, for example, the caller lspeaking to the agent 12 over the telephone. Audio can include sound or an electrical or other representation of sound. Sound may be stored and transmitted in a variety of ways, including in digital or audio data file.

Additionally, in one example embodiment, the method of providing a caller profile to an agent 12 can include transmitting audio from the agent 12 to the caller 1. The method of providing a caller profile to an agent 4 can also include amending the content associated with the unique identifier. As outlined above, amending content can include changing or modifying content by adding new content, deleting all or some of the content, or altering the content in any way. In one embodiment, the amending is performed by an entity chosen from the caller 1 and the agent 4.

This claimed invention provides for the exchange of billing information over the phone in a manner that is faster and more secure for both consumers and businesses. The system and methods of the claimed invention transmit identification and billing information to and from a centrally located database, such as a cloud database. This database can be operated, updated, and maintained by the caller, the recipient of the call, or a third party. For security purposes, the owner of the profile can secure the information with a password, PIN, or other security code. The claimed invention provides significant improvements over existing methods of information transfer (e.g., billing information), because the disclosed systems and methods are faster and more secure.

A PIN includes a personal identification number or code. The term PIN is often redundantly used within the context of “PIN number,” which should be considered synonymous with PIN. Traditionally the term “PIN” means a numeric passcode (i.e., a number) shared between a user and a system that can be used to authenticate the user to the system. PIN can include any personal identification code consisting of numbers, words, or combinations thereof

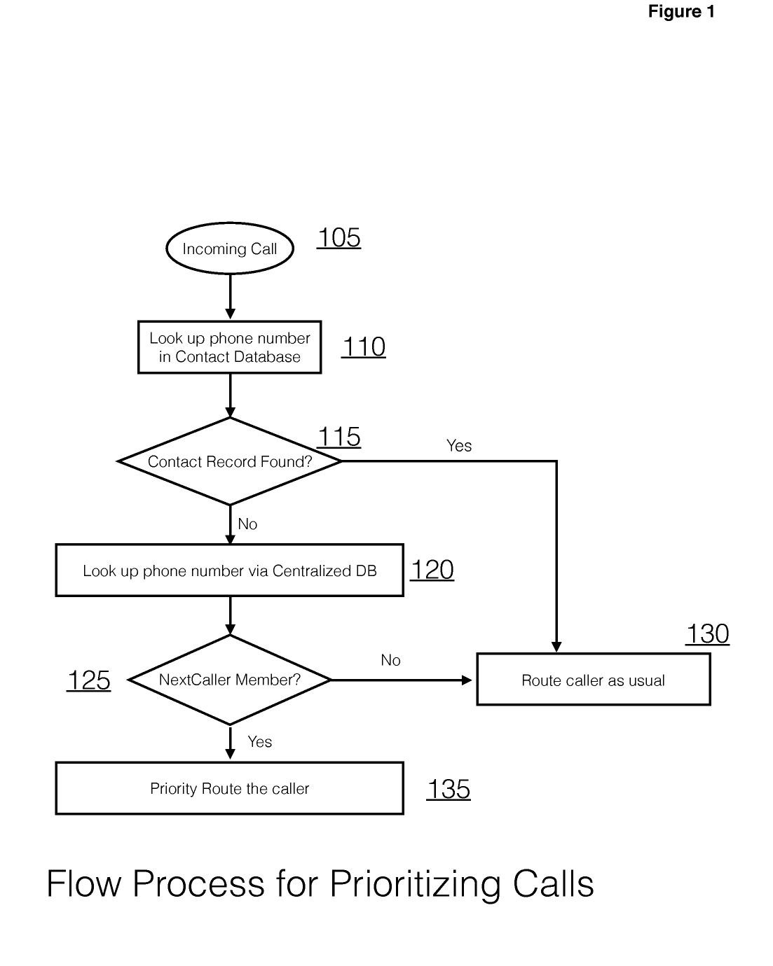

FIG. 1 shows one example of the process flow for identifying and priority routing a caller. As shown in the example of FIG. 1, a “caller” places a telephone call to a called party by dialing the called party's number and waiting for the called Party to answer the call. To the called party, this is an incoming call as shown in block 105 of FIG. 1. This example can also include one or more intermediary parties, who transfer the incoming call of the caller to one or more call recipients, who then answer the call.

Upon receiving the incoming call, the called party looks up the caller's phone number in a contact database in block 110. If a contact record is found in block 115, the caller is routed according to an established routine. For example, the caller can be routed in a first-in, first-out routine to a queue, where a called party can service the call. Other routines can also be used. If a contact record is not found in block 115, the process continues to block 120 where the caller's phone number is looked up via a centralized database, such as the contact database illustrated in the Figures. If the phone number is determined to be that of a NextCaller member (in block 125), the caller is routed with priority to the called party as the NextCaller.

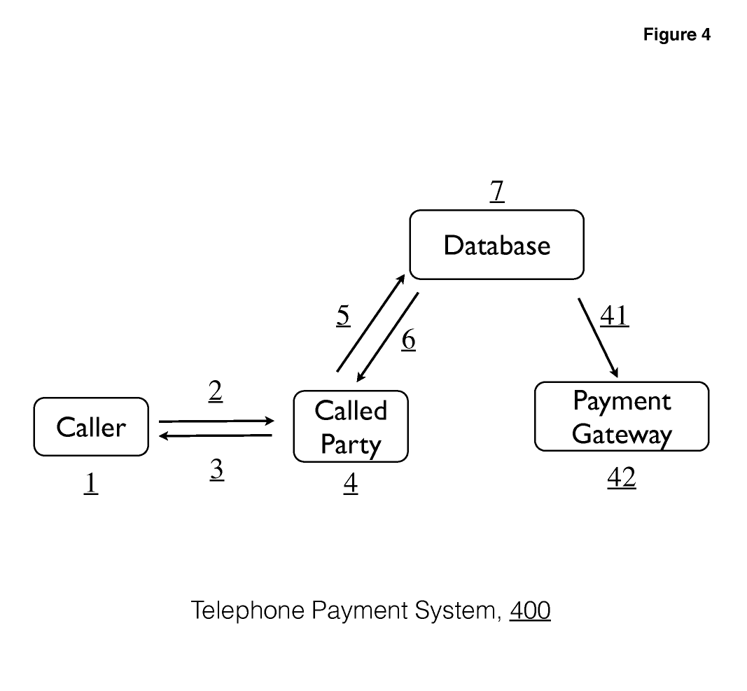

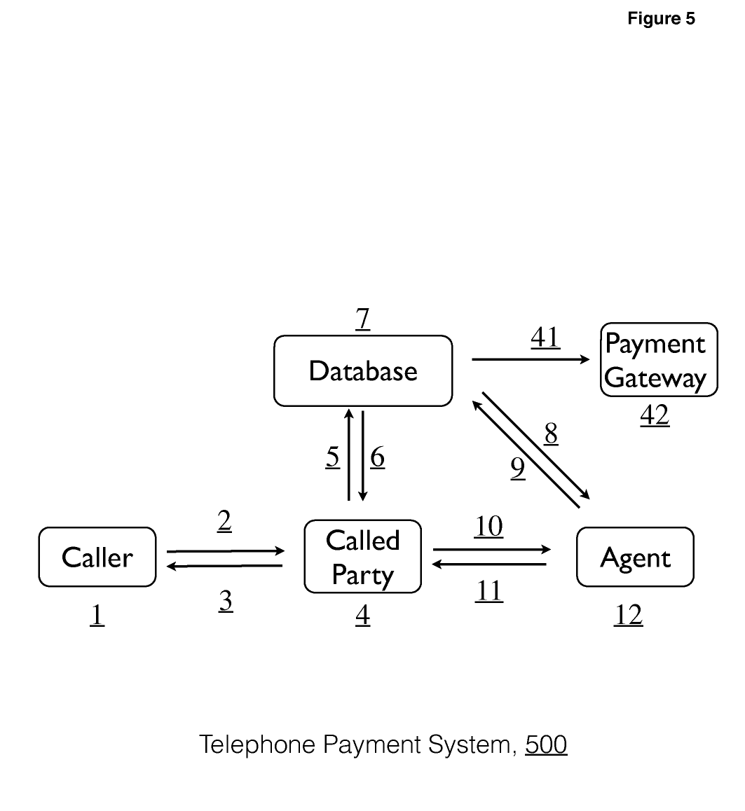

FIGS. 4 and 5 show a telephone payment system 400, 500, respectively, and illustrates a method of processing a telephone payment. The telephone payment systems 400, 500 include a caller 1, a called party 4, a database 7, and a payment gateway 42. FIG. 5 includes an agent 12 that can also communicate with the parties. FIGS. 4 and 5 also show communications lines for transmitting/acquiring profile information, payment information, and the like between the parties. For example, the caller 1 can transmit profile and payment information to the called party 4 over communication line 2. Similarly, the called party 4 can transmit information to the caller 1 over communication line 3. Additionally, the called party 1 can transmit profile and payment information to a database 7 over communication line 5, and the database 7 can transmit content to the called party 4 over communication line 6. Further, the database 7 can transmit information to the payment gateway 42 over communication line 41.

In one example embodiment of the claimed invention, the telephone payment system 400 transmits billing information from the cloud database 7 to a payment gateway 42. In one embodiment of the telephone payment system 400, the caller 1 verbally transmits a PIN to the called party 4. The PIN can be chosen from a number, a word, or a combination of words or numbers. In one example embodiment of the claimed invention, the PIN includes a numerical PIN that is spoken out to a recipient capable of understanding the spoken words.

Similarly, the PIN can be electronically transmitted from the caller 1 to the called party 4. That is, the PIN can be conveying using nonverbal, digital or analog transmission. For example, one manner of conveying the information can be by using the keypad of a telephone to communicate tones or numbers, rather than using the telephone's microphone to transmit spoken verbal information.

Typically, a user is required to provide a non-confidential user identifier or token (the user ID) and a confidential PIN to gain access to the system. Upon receiving the user ID and PIN, the system looks up the PIN based upon the user ID and compares the looked-up PIN with the received PIN. The user is granted access only when the number entered matches with the number stored in the system. So, despite the name, a PIN does not personally identify the user. As outlined above, in at least one embodiment of the disclosed telephone payment system, the caller 1 transmits a PIN to the called party 4, who transmits the PIN to the cloud database 7, which, upon verification, transmits the caller's billing information to the payment gateway 42 of the called party.

In one example embodiment of the claimed invention, the cloud database 7 of the telephone payment system 400 transmits credit card information to the payment gateway 42. Credit card information can include information associated with a particular credit card, such as the card number, verification code, and billing information (e.g., cardholder's address, phone number, etc.) associated with the card. Similarly, the cloud database 7 can also transmit bank account information to the payment gateway 42. Likewise, the cloud database 7 can transmit encrypted billing information to the payment gateway 42. Bank account information can include information associated with a particular bank account, such as the account number, routing number, bank address, and information associated with the account (e.g., account holder's address, phone number, etc.).

The billing information can be encrypted or otherwise encoded such that the messages or information is only readable by authorized parties having the proper code for decrypting, decoding, or accessing that information. In an encryption scheme, the message or information, referred to as plaintext, is encrypted using an encryption algorithm, turning it into an unreadable ciphertext. This is usually done with the use of an encryption key, which specifies how the message is to be encoded. Any adversary that can see the ciphertext should not be able to determine anything about the original message. An authorized party, however, is able to decode the ciphertext using a decryption algorithm, that usually requires a secret decryption key that adversaries do not have access to. Non-limiting examples of cryptographic protocols include Transport Layer Security (TLS) and its predecessor, Secure Sockets Layer (SSL).

An example method for processing telephone payment in accordance with the claimed invention includes establishing a telephone connection between a called party 4 and a caller 1, acquiring a unique identifier from the caller 1, and transmitting the unique identifier to a cloud database 7. Acquiring the unique identifier can include gaining, getting, or receiving. In one example, acquiring the unique identifier from a caller is accomplished by reading the Caller ID information transmitted by the caller.

Once the unique identifier is acquired, the called party 4 queries the cloud database 7 for a record corresponding to the unique identifier and verifies a PIN associated with the caller 1. The cloud database 7 then transmits the billing information to the payment gateway 42 of the called party 4. Verifying a PIN associated with the caller 1 can include comparing the PIN provided by the caller 1 to the PIN associated with the caller's profile in the cloud database 7 to ascertain the authenticity or correctness of the information provided (as by examination or comparison). In one example embodiment of the claimed invention verifying a PIN associated with the caller 1 can include ascertaining that the PIN provided by the caller 1 matches the PIN in the secure profile in database 7. The database 7 can then respond to a matching PIN by sending the user's billing information to the computer of the agent 12 (in FIG. 5), which is read and processed by the same software that allows the agent 12 to interact with the database 7. If the PIN does not match, the database 7 does not send any information to the agent 12.

The method of processing the telephone payment can include acquiring a telephone number for the Caller 1, transmitting the telephone number of the caller 1 to the cloud database 7, and querying the cloud database 7 for a record corresponding to the telephone number of the caller 1.

As outlined above, the method of processing telephone payment can include transmitting credit card information directly from the cloud database 7 to the payment gateway 42 of the called party 4. Transmitting credit card information directly from the cloud database 7 to the payment gateway 42 can include sending the credit card information to the payment gateway 42 without first sending it to an intermediary recipient, such as a call center agent. Likewise, other billing information other than credit card information can be transmitted directly from the cloud database 7 to the payment gateway 42 without an intermediary recipient of that billing information. For example, direct transmission of billing information from the cloud database 7 to a payment gateway 42 would avoid transmission of that billing information to the called party 4 or its agent 12, thereby providing significant data security benefits.

In one example embodiment, processing telephone payment can include verbally transmitting the PIN associated with the caller 1 from the caller 1 to the called party 4. Verbally transmitting can include conveying the information with words, such as speaking the words. In one example of the method of processing telephone payments, when the caller 1 is ready to provide his or her billing information, he or she can simply state the PIN or password associated with the profile by speaking it over the telephone line. If the password matches the password stored in the database 7, the database 7 sends the billing information directly to the payment gateway 42. If more than one billing method is saved in the database 7, the agent 12 (shown in FIG. 5) can choose which billing method to use, by asking the caller. When the agent 12 requires information to choose between multiple payment options, the full information remains hidden, and only descriptors such as “primary checking account” or “Visa credit card” are available for identifying and distinguishing the different accounts.

In one embodiment of the claimed invention, the method of processing telephone payment includes transmitting the PIN associated with the caller 1 from the called party 4 to the cloud database 7. In one embodiment, the cloud database 7 is linked to the called party's 4 computer system, allowing for immediately and directly sending the billing information to the payment gateway 42.

One advantage of the methods of the claimed invention is that the user can provide the PIN to rapidly and accurately conduct a transaction. These methods provide significant advantages over existing methods of paying over the phone, which include reading out all the numbers of the credit card, bank account, or other payment method, and reciting the associated billing information.

We claim:

1. A telephone payment system for processing a telephone payment of a caller comprising:
a called party computer configured to receive a telephone call from the caller and to receive a unique identifier from the caller and to receive a PIN from the caller;
a contact database storing a profile information record of the caller corresponding to the unique identifier of the caller and further storing a billing information record of the caller corresponding to a PIN associated with the caller,
wherein the contact database transmits billing information from the billing information record of the caller to a payment gateway for processing the telephone payment of the caller when the PIN received by the called party computer matches the PIN associated with the caller stored in the contact database.

2. The telephone payment system of claim 1, wherein the called party computer is further configured to transmit the received PIN to the contact database.

3. The telephone payment system of claim 1, wherein the contact database is configured to transmit the billing information directly from the contact database to the payment gateway without providing the billing information to the called party computer.

4. The telephone payment system of claim 1, wherein receiving the PIN associated with the caller includes receiving a verbal transmission of the PIN from the caller.

5. The telephone payment system of claim 1, wherein the PIN includes at least one of a number and a letter.

6. The telephone payment system of claim 1, wherein the contact database is a cloud database.

7. The Telephone Payment System of claim 1, wherein the unique identifier received by the called party computer includes a telephone number of the caller.

8. The telephone payment system of claim 1, wherein the billing information transmitted from the contact database to the payment gateway includes credit card information.

9. The telephone payment system of claim 1, wherein the billing information transmitted from the contact database to the payment gateway includes bank account information.

10. The telephone payment system of claim 1, wherein the contact database includes an encryption module configured to transmit encrypted billing information to the payment gateway.

11. A method for processing a telephone payment of a caller, the method comprising:
establishing a telephone connection between a caller and a called party;
acquiring, by the called party, a unique identifier from the caller;
querying a contact database for a profile information record corresponding to the unique identifier;
receiving a PIN associated with the caller;
comparing the received PIN to the profile information record of the caller;
transmitting billing information of the caller to a payment gateway for processing the telephone payment of the caller when the PIN of the caller matches the profile information of the caller.

12. The method of claim 11, wherein the unique identifier includes a telephone number of the caller.

13. The method of claim 12, wherein the contact database is a cloud database.

14. The method of claim 11, wherein transmitting billing information of the caller to the payment gateway includes transmitting bank account information from the contact database to the payment gateway.

15. The method of claim 11, wherein transmitting billing information of the caller to the payment gateway includes transmitting credit card information from the contact database to the payment gateway.

16. The method of claim 11, wherein receiving the PIN associated with the caller includes the called party verbally receiving the PIN from the caller.

17. The method of claim 11, wherein transmitting the billing information of the caller to the payment gateway includes directly transmitting the billing information to the payment gateway without providing the billing information to the called party.

18. The method of claim 11, wherein the PIN includes at least one of a number and a letter.

19. The method of claim 11, wherein receiving the PIN associated with the caller includes the called party electronically receiving the PIN from the caller.

20. The method of claim 19, wherein electronically receiving the PIN associated with the caller includes electronically receiving the PIN from the caller via a telephone keypad.
